(19) United States
(12) Patent Application Publication
(10) Pub. No.: US 2009/0049404 A1
(43) Pub. Date: Feb. 19, 2009

(54) INPUT METHOD AND APPARATUS FOR DEVICE HAVING GRAPHICAL USER INTERFACE (GUI)-BASED DISPLAY UNIT

(75) Inventors: Han-chul Jung, Seoul (KR); O-jae Kwon, Seoul (KR); Chang-beom Shin, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/047,531

(22) Filed: Mar. 13, 2008

(30) Foreign Application Priority Data
Aug. 16, 2007 (KR) 2007-82286

(51) Int. Cl. G06F 3/048

(52) U.S. Cl. 715/810

(57) ABSTRACT

An input method and apparatus for a device having a graphical user interface (GUI)-based display unit includes allocating at least one region for a plurality of input units disposed on the device, defining input types different from each other for the allocated region, and controlling menu displayed on the display unit according to a signal input in the allocated region based on the defined input types. According to the method and apparatus, the use method and layout of a physically fixed input apparatus can be flexibly changed, thereby increasing the use scope of input types. Also, by integrating navigation inputs, character inputs, and button inputs, efficiency of using the area of a mobile device increases.

### CROSS-REFERENCE TO RELATED APPLICATIONS

This application claims priority under 35 U.S.C. §119(a) from Korean Patent Application No. 10-2007-0082286, filed on Aug. 16, 2007, in the Korean Intellectual Property Office, the disclosure of which is incorporated herein in its entirety by reference.

### BACKGROUND OF THE INVENTION

1. Field of the Invention

The present general inventive concept relates to an input method and apparatus for a device having a graphical user interface (GUI)-based display unit, and more particularly, to an input method and apparatus to variably allocate regions for a plurality of input units according to a GUI screen, define inputs methods different from each other in the allocated regions, and control a menu.

2. Description of the Related Art

According to recent development trends of portable devices, various functions are added to main functions of a portable device such as a mobile phone generally having a call function and a short message service function. For example, mobile phones recently include functions such as a reproduction function of MP3 music files, a video recording and reproduction functions of a digital camera, an electronic dictionary function, an Internet web surfing function, digital TV functions, etc. Such portable devices include generally graphical user interface (GUI)-based display units.

Also, although a number of functions of portable devices has increased, the physical size of such devices has been constantly reduced. Accordingly, many attempts have been made to map several functions to a limited number of buttons.

The functionality increase of portable devices has been accompanied by development of apparatuses and methods to control the respective functions. From the viewpoint of human behavior, users are interested in inexpensive electronics devices with multiple functions and small sizes.

Though there is no particular difficulty in manufacturing mobile devices with a variety of functions and small sizes due to recent technological developments, the demands for user interfaces to quickly and easily controlling a portable terminal have increased. For example, there have been many attempts to develop user interfaces to reduce a number of key input operations that a user has to follow in order to perform a predetermined function and allow easier management, retrieval and reproduction of digital content such as photos, moving pictures, music files, and email.

In this regard, increasing the number of buttons for inputting a plurality of functions as described above leads to increased complexity in manipulating the portable terminal due to a limited size thereof. Also, if the number of buttons for key inputs is not increased, the number of times of a key to input a predetermined function has to pressed should be increased.

In addition, due to complicated inputs for functions as described, remembering the button inputs and input sequences corresponding to all required functions by a user is difficult, and accordingly, different functions than the desired ones may be executed due to incorrect button inputs.

FIG. 1 is a diagram illustrating a portable device having menu selection buttons and character input buttons according to the conventional art.

Referring to FIG. 1, the portable device has a direction button 120, a confirmation button 130, a cancel button 140 to manipulate a GUI menu displayed on a display unit 110, and a plurality of key buttons 150 to input numbers and characters.

As illustrated in FIG. 1, since the portable device includes many separated buttons for performing different functions, complexity of using the portable terminal is quite high. Also, flexibility of an input method using a type thereof of fixed input interface is limited.

### SUMMARY OF THE INVENTION

The present general inventive concept provides an input method and apparatus for a device having a graphical user interface (GUI)-based display unit, by which regions are variably allocated for a plurality of input units according to a GUI screen and input types different from each other are defined in the allocated regions to easily control a menu.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing an input method for a device having a graphical user interface (GUI)-based display unit, the method including allocating at least one region for a plurality of input units disposed in the device, defining input types different from each other for the allocated region, and based on the defined input types, controlling a menu displayed on the display unit according to a signal input in the allocated region based on the defined input types.

In the defining of the input types, the allocated region may be defined with at least one input type of a button input, a touch scroll input, and a relative coordinate input.

In the allocating of the at least one region, regions may be allocated variably with respect to a layout of the menu displayed on the display unit.

The controlling of the menu may be independently performed according to a signal input in each allocated region.

In the controlling of the menu, when the input type defined in the allocated region is a relative coordinate input method, continuous coordinates among the plurality of input units may be input by combining the plurality of input units.

The input of the continuous coordinates among the plurality of input units may be performed by combining in a series of time last input coordinates recognized by a first input unit and start input coordinates recognized by a second input unit adjacent to the first input unit and to calculate coordinates among the plurality of input units.

The method may further include performing a character input according to the continuous coordinates input.

Each of the input units may be formed as a combination of a touch pad and a tact switch.

In the defining of the input type, the input type may be defined so that a plurality of input units in the allocated region can be integrated to operate as a same input.

The method may further include displaying a boundary of the allocated region using backlight.

The foregoing and/or other aspects and utilities of the general inventive concept may also be achieved by providing an input apparatus usable with a device having a graphical user interface (GUI)-based display unit, the apparatus including a region allocation unit to allocate at least one region for a plurality of input units disposed in the device, an input type defining unit to define input types different from each other for the allocated region, and a controller to control a menu displayed on the display unit according to a signal input in the allocated region based on the defined input types.

The input type defining unit may define the allocated region with at least one input type of a button input, a touch scroll input, and a relative coordinate input.

The region allocation unit may allocate regions variably with respect to a layout of the menu displayed on the display unit.

The controller may operate by at least one input among the button input, the touch scroll input, and the relative coordinate input according to a signal input in each allocated region.

When the input type defined in the allocated region is a relative coordinate input method, the controller may combine the plurality of input units so that continuous coordinates among the plurality of input units can be input.

The controller may further include a coordinates calculation unit to combine in a series of time last input coordinates recognized by a first input unit and start input coordinates recognized by a second input unit adjacent to the first input unit and to calculate coordinates among the plurality of input units.

Each of the input units may be formed as a combination of a touch pad and a tact switch.

The input type defining unit may define input types so that a plurality of input units in the allocated region can be integrated to operate as a same input.

The apparatus may further include a boundary to display unit displaying a backlight at the boundary of the plurality of input units corresponding to the boundary of the allocated region.

The foregoing and/or other aspects and utilities of the general inventive concept may also be achieved by providing a computer readable recording medium having embodied thereon a computer program to execute a method, the method includes allocating at least one region for a plurality of input units disposed on a device, defining input types different from each other for the allocated region, and controlling menu displayed on a display unit of the device according to a signal input in the allocated region based on the defined input types.

The foregoing and/or other aspects and utilities of the general inventive concept may also be achieved by providing use method and layout of a physically fixed input apparatus can be flexibly changed, thereby increasing the use scope of input types. Also, by integrating navigation inputs, character inputs, and button inputs, efficiency of using the area of a mobile device increases.

The foregoing and/or other aspects and utilities of the general inventive concept may also be achieved by providing an electronic device including a display unit to display a graphical user interface, the graphical user interface including a plurality of layouts each having a plurality of regions, an input method defining unit to assign input functions to the plurality of regions, respectively, and a controller to select a respective layout to be displayed on the display unit and to manipulate an orientation of the respective layout with respect to the display unit.

The controller may include at least one of a button control unit, a touch scroll input control unit and a relative coordinate input control unit.

The foregoing and/or other aspects and utilities of the general inventive concept may also be achieved by providing a method of operating an electronic device, the method includes selecting at least one layout having a plurality of regions of a plurality of layouts of a graphical user interface to be displayed on a display unit, assigning input functions to the plurality of regions, respectively, of the at least one layout, and manipulating an orientation of the at least one layout with respect to the display unit.

Furthermore, unlike a touch screen method, physical tactile feedback is provided such that a more familiar user environment can be provided.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a diagram illustrating a portable device having menu selection buttons and character input buttons according to the conventional art;

FIG. 2 is a flowchart illustrating an input method for a device according to an embodiment of the present general inventive concept;

FIG. 3 is a diagram illustrating a case where regions of 4×4 input units are allocated according to a GUI screen structure according to an embodiment of the present general inventive concept;

FIG. 4 is a diagram illustrating a case where regions of input units are allocated according to another screen structure according to another embodiment of the present general inventive concept;

FIG. 5 is a diagram illustrating input processing of input of continuous coordinates in neighboring input units according to an embodiment of the present general inventive concept;

FIG. 6 is a diagram illustrating a touch pad and a tact switch to form each input unit according to an embodiment of the present general inventive concept;

FIG. 7 is a diagram illustrating input of a character by inputting continuous coordinates according to an embodiment of the present general inventive concept; and

FIG. 8 is a functional block diagram illustrating an input apparatus for a device according to an embodiment of the present general inventive concept.

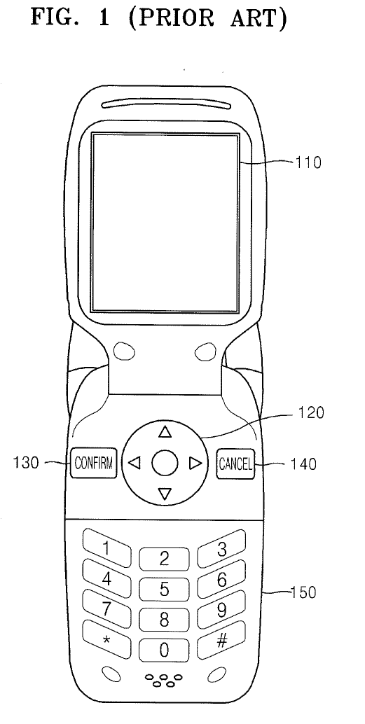

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

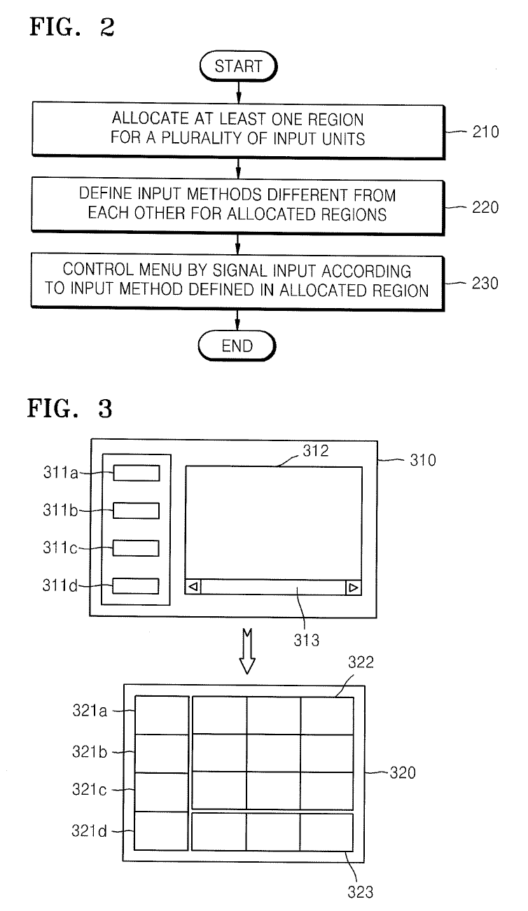

FIG. 2 is a flowchart illustrating an input method for a device according to an embodiment of the present general inventive concept.

Referring to FIG. 2, according to the present embodiment, the input method includes allocating at least one region for a plurality of input units disposed on a device having a graphical user interface (GUI)-based display unit in operation 210, defining input types different from each other for the allocated region in operation 220, and based on the defined input types, controlling a menu displayed on the display unit according to a signal input in the allocated region in operation 230.

That is, according to the present embodiment, though a fixed input interface is used, regions of the interface can be flexibly divided and input types different from each other can be defined so that the different input methods can be combined. Accordingly, a user can perform a variety of inputs intuitively and immediately according to the displayed GUI-based screen structure.

The input types include, for example, a key button input to select each menu, a touch scroll input to control a scroll bar on a screen, and a relative coordinate input for navigation pointing.

In order to allow a variety of input types described above to be flexibly used according to a menu and layout appearing on a GUI screen, first, one or more regions are allocated for a plurality of input units in operation 210, and input types such as a button input or a relative coordinate input are defined for the allocated regions in operation 220. Then, according to a signal input in the allocated region, for example, according to an input by a user such as a click, scroll, or pointing, the menu of the GUI screen is controlled in operation 230. Thus, the process to control the menu of the screen is performed independently by an input signal input in each allocated region.

FIG. 3 is a diagram illustrating a case where regions of 4×4 input units are allocated according to a GUI screen structure according to an embodiment of the present general inventive concept.

Referring to FIG. 3, a GUI screen in a screen 310 like a webpage is displayed on top of the figure and an input interface 320 formed as 4×4 input units is at a bottom.

Though the illustrated input interface 320 is formed as 4×4 input units, the input interface may be a keyboard in which the layout [line×column] may be 3×4 or 4×3 or may be a QWETRY keyboard, which is a general-purpose keyboard of a computer.

Also, assuming that an input unit according to the current embodiment, which will be explained below, is formed as a combination of a touchpad 640 (FIG. 6) and a tact switch 650 (FIG. 6).

Referring to FIG. 6, each of a plurality of input units 610 through 630 is formed as a combination of a touchpad 640 with which relative coordinates can be input, and a tact switch 650 which plays a role of a button.

The touchpad 640 is an input unit including a small flat plate having a pressure sensor to sense the pressure of a finger or a stylus pen, such that a pointer moves on a screen, thereby allowing respective coordinates position information to be recognized by a computer. At present, the touchpad 640 is widely used for notebook computers and ordinary desktop computers. The touchpad 640 includes many layers formed of different materials. The top layer is a finger pad, and in a layer immediately below the top layer, horizontal and vertical electrodes separated by a thin insulation body are arranged in a width direction and in a length direction to form a lattice shape. A circuit board to which the electrodes layer is connected is disposed immediately below the electrodes layer. The electrodes layer is charged with a predetermined alternating current (AC), and if a finger approaches the electrode lattice, current flow to the electrode layer is cut off, and the cutoff of the current is sensed by the circuit board. The position on the pad which is first touched by the finger is recorded so that the continuing motion of the finger can be identified.

Meanwhile, bulk, radial and synthesizer module tact switches may be used as the tact switch 650.

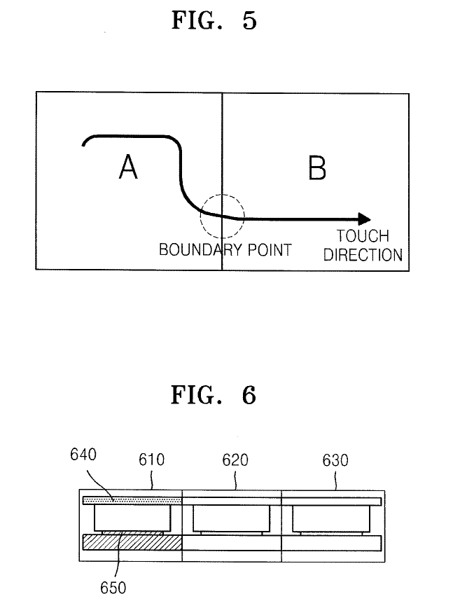

Accordingly, with each of the input units, a button input as a click and a relative coordinate input can be performed. Also, as will be explained below with reference to FIG. 5, the input units can be operated, for example, as a touch pad 640 (FIG. 6) having a much wider area by combining the plurality of input units.

Referring again to FIG. 3, the GUI screen appearing on the screen 310 is formed with four menus 311a through 311d on the left, a main screen 312 in which webpage content of a main body appears, and a scroll bar 313 to scroll a portion not yet appearing on the screen 312.

Meanwhile, corresponding to each of the GUI screen structures, regions of input units can be divided into button areas 321a through 321d to allow the four menus on the left to be selected, a touchpad area 322 to allow the main body of the webpage to be pointed, and an area 323 to control the scroll bar.

By allocating each region in the input interface 320 to match with the division of the GUI screen and to define an input type, as described above, in each region, the user may select a menu by clicking one of the four buttons 321a through 321b on the left, or may scroll the screen by touch scrolling the scroll bar region 323, or may make independently a pointing input in the region 322 in which relative coordinates can be input. Also, while the pointer moves, the input unit may be pressed so that a click function can be performed at a position of the pointer.

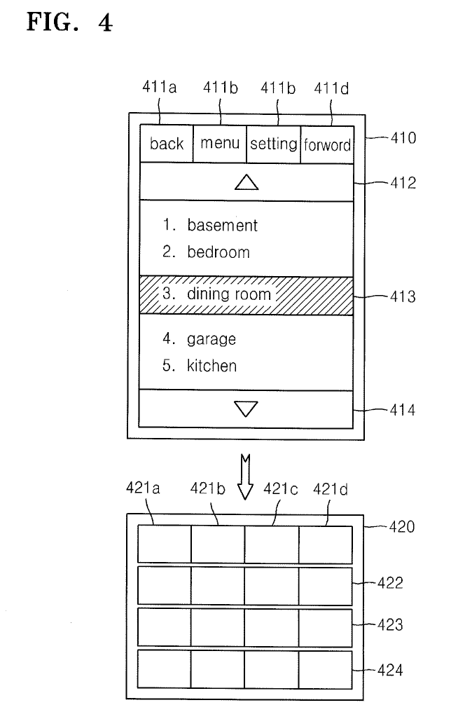

FIG. 4 is a diagram illustrating a case where regions of input units are allocated according to another screen structure according to another embodiment of the present general inventive concept.

Referring to FIG. 4, on a top of the screen, four menus 411a through 411d appear, and an up/down arrows 412 and 414 to allow a list to be scrolled, and content 413 of the main body of the list are also illustrated.

In the screen structure, division of regions for input units can be performed as follows. First, the screen is divided into regions 421a through 421d to correspond to the menus on the top, respectively, regions 422 and 424 to select the up/down scroll, and a region 423 to select the main body of the list.

Then, in defining each region, the top four input units 421a through 421d are defined as button input types, and the regions 423 to select the up/down scroll regions 422 and 424 and the main body of the list are defined as integrated button input types. That is, for example, in the region 422 in which an up arrow appears, whichever input unit from among the four input units 421a through 421d in the region is clicked, the clicked unit can operate to scroll the list upwards. That is, the region 422 can be configured so that many input units 421a through 421d can handle an identical function. In this way, by integrating and defining the plurality of input units so that the plurality of input units 421a through 421d can function as a same input, therefore user's input accessibility can be increased. Also, in order to scroll the list downwards, any unit in the region 424 in which the down arrow appears, the list can be scrolled down.

Furthermore, in this case, a boundary of the allocated regions formed with a plurality of input units 421a through 421d can be indicated by using a backlight for convenience of users.

FIG. 5 is a diagram illustrating input processing of continuous coordinates in neighboring input units A and B according to an embodiment of the present general inventive concept.

Referring to FIG. 5, the plan view of two neighboring input units (A, B) illustrates that when input types defined in allocated regions are relative coordinate input methods, continuous coordinates can be input by combining a plurality of input units.

That is, each input unit may operate as an independent touchpad 640, for example, as illustrated in FIG. 6, but may also form a touchpad 640 with a much wider area by combining many input units.

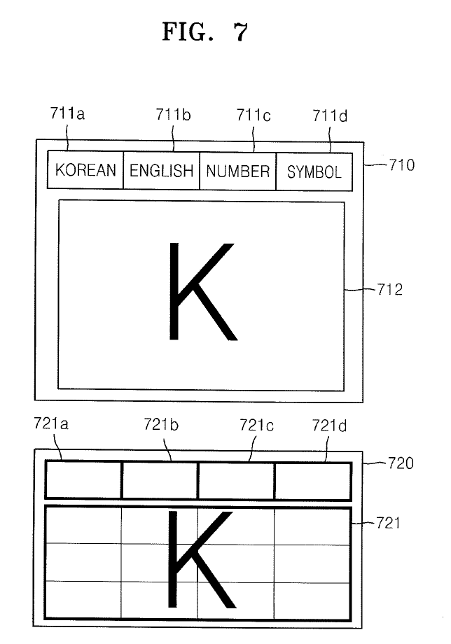

In this case, by combining in a series of time and calculating last input coordinates that are recognized by a first input unit (A) and start input coordinates that are recognized by a second input unit (B) adjacent to the first input unit (A), the input units A and B can operate as if the input units are one touchpad 640 (FIG. 6). Thus, an additional function as a character input illustrated in FIG. 7 can also be performed.

FIG. 7 is a diagram illustrating inputting of a character by inputting continuous coordinates according to an embodiment of the present general inventive concept.

Referring to FIG. 7, regions of an input interface 720 are allocated as the screen structure illustrated in a screen 710. Accordingly, if the region 721 in which a character is input is defined as a relative coordinate input type and a character “K” is input by using a finger or a stylus pen, a same character is displayed on the main screen 712 of the screen 710.

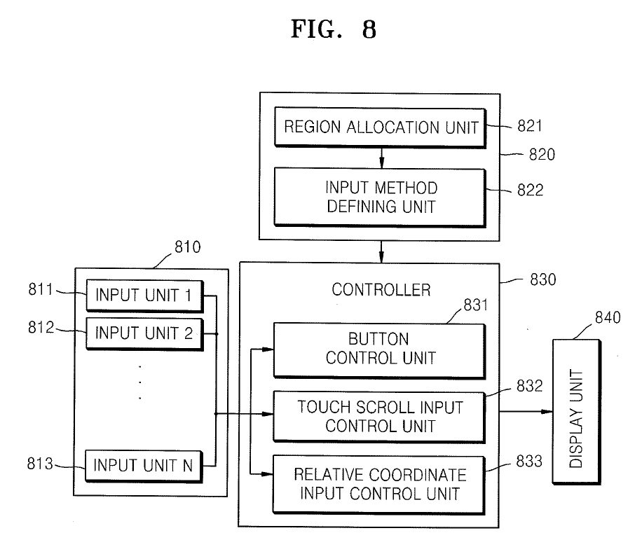

FIG. 8 is a functional block diagram illustrating an input apparatus for a device according to an embodiment of the present general inventive concept.

Referring to FIG. 8, the input apparatus includes a region allocation unit 821 to allocate at least one region for a plurality of input units 811 through 813 disposed on the device, an input type defining unit 822 to define input types different from each other for the allocated region, and a controller 830, based on the defined input types, to control a menu displayed on the display unit 840 according to a signal input in the allocated region. Also, the controller 830 may further include a button input control unit 831, a touch scroll input control unit 832, and a relative coordinate input control unit 833 according to input types. Also, the controller 830 may further include a coordinate calculation unit (not illustrated) combining in a series of time the last input coordinates recognized by a first input unit and the start input coordinates recognized by a second input unit adjacent to the first input unit and calculating coordinates.

In an operation process, the region allocation unit 821 allocates one or more regions formed with a plurality of input units 811 through 813 based on the layout of a menu appearing on a GUI screen of a display unit 840 so that a plurality of input types as described above can be flexibly used, and the input type defining unit 822 defines an input type such as a button input or relative coordinate input, for an allocated region.

Then, by using an input interface 810 formed with a plurality of input units 811 through 813, a variety of command signals such as click, scroll, and pointing are input in the allocated region. When the input command signal is controlled by the controller 830, if the command signal is input in a button input region, the button input control unit 831 controls the signal, if the command signal is input in a touch scroll region, the touch scroll input control unit 832 controls the signal, and if the command signal is input in a relative coordinate input unit, the relative coordinate input control unit 833 controls the signal. The signal input in each region according to the different input type finally controls a menu of the GUI screen displayed on the display unit 840 through the control units 831 through 833 handling respective regions. The process of controlling the menu of the screen with the input signal as described above is performed independently in each allocated region.

Additionally, a boundary display unit (not illustrated) to display a backlight on a boundary point corresponding to a region may further be included so that the user can easily identify the boundary of the region formed with a plurality of input units 811, 812 and 813.

The input method and apparatus of the present general inventive concept can be used for mobile devices (mobile phones, smart phones, MP3 players, portable multimedia players (PMP), navigation devices, etc.), open web devices, input apparatuses for character input, and controllers in a home network environment (IPTV remote controllers, lighting remote controllers, and PC remote controllers) and by changing a size and number of buttons, can also be applied to home appliances, vehicle, and industrial devices as well as mobile devices.

The input method of a device having a GUI-based display unit according to the present general inventive concept can also be embodied as computer-readable codes on a computer readable recording medium.

Also, the data structure used in the various embodiments of the present general inventive concept described above can be recorded on a computer readable recording medium through a variety of ways.

The present general inventive concept can also be embodied as computer-readable codes on a computer-readable medium. The computer-readable medium can include a computer-readable recording medium and a computer-readable transmission medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. An input method for a device having a graphical user interface (GUI)-based display unit, the method comprising:
allocating at least one region for a plurality of input units disposed on the device;
defining input types different from each other for the allocated region; and
controlling a menu displayed on the display unit according to a signal input in the allocated region based on the defined input types.

2. The method of claim 1, wherein in the defining of the input types, the allocated region is defined with at least one input type of a button input, a touch scroll input, and a relative coordinate input.

3. The method of claim 2, wherein in the allocating of the at least one region, regions are allocated variably with respect to a layout of the menu displayed on the display unit.

4. The method of claim 3, wherein the controlling of the menu is independently performed according to a signal input in each allocated region.

5. The method of claim 4, wherein in the controlling of the menu, when the input type defined in the allocated region is a relative coordinate input method, continuous coordinates among the plurality of input units can be input by combining the plurality of input units.

6. The method of claim 5, wherein the input of the continuous coordinates among the plurality of input units is performed by combining in a series of time last input coordinates recognized by a first input unit and start input coordinates recognized by a second input unit adjacent to the first input unit and to calculate coordinates among the plurality of input units.

7. The method of claim 6, further comprising:
performing a character input according to the continuous coordinates input.

8. The method of claim 6, wherein each of the input units is formed as a combination of a touch pad and a tact switch.

9. The method of claim 8, wherein in the defining of the input type, the input type is defined so that a plurality of input units in the allocated region can be integrated to operate as a same input.

10. The method of claim 9, further comprising:
displaying a boundary of the allocated region using backlight.

11. An input apparatus usable with a device having a graphical user interface (GUI)-based display unit, the apparatus comprising:
a region allocation unit to allocate at least one region for a plurality of input units disposed on the device;
an input type defining unit to define input types different from each other for the allocated region; and
a controller to control a menu displayed on the display unit according to a signal input in the allocated region based on the defined input types.

12. The apparatus of claim 11, wherein the input type defining unit defines the allocated region with at least one input type of a button input, a touch scroll input, and a relative coordinate input.

13. The apparatus of claim 12, wherein the region allocation unit allocates regions variably with respect to a layout of the menu displayed on the display unit.

14. The apparatus of claim 13, wherein the controller operates by at least one input among the button input, the touch scroll input, and the relative coordinate input according to a signal input in each allocated region.

15. The apparatus of claim 14, wherein when the input type defined in the allocated region is a relative coordinate input method, the controller can combine the plurality of input units so that continuous coordinates among the plurality of input units can be input.

16. The apparatus of claim 15, wherein the controller further comprises:
a coordinates calculation unit to combine in a series of time last input coordinates recognized by a first input unit and start input coordinates recognized by a second input unit adjacent to the first input unit and to calculate coordinates among the plurality of input units.

17. The apparatus of claim 16, wherein each of the input units is formed as a combination of a touch pad and a tact switch.

18. The apparatus of claim 17, wherein the input type defining unit defines input types so that a plurality of input units in the allocated region can be integrated to operate as a same input.

19. The apparatus of claim 18, further comprising:
a boundary displaying unit to display a backlight at a boundary of the plurality of input units corresponding to the boundary of the allocated region.

20. A computer-readable recording medium having embodied thereon a computer program to execute a method, the method comprises:
allocating at least one region for a plurality of input units disposed on a device;
defining input types different from each other for the allocated region; and
controlling menu displayed on a display unit of the device according to a signal input in the allocated region based on the defined input types.

21. An electronic device, comprising:
a display unit to display a graphical user interface, the graphical user interface including a plurality of layouts each having a plurality of regions;
an input method defining unit to assign input functions to the plurality of regions, respectively; and
a controller to select a respective layout to be displayed on the display unit and to manipulate an orientation of the respective layout with respect to the display unit.

22. The device of claim 21, wherein the controller comprises:
at least one of a button control unit, a touch scroll input control unit and a relative coordinate input control unit.

23. A method of operating an electronic device, the method comprising:
selecting at least one layout having a plurality of regions of a plurality of layouts of a graphical user interface to be displayed on a display unit;
assigning input functions to the plurality of regions, respectively, of the at least one layout; and
manipulating an orientation of the at least one layout with respect to the display unit.
